(19) United States
(12) Patent Application Publication
(10) Pub. No.: US 2002/0047982 A1
(43) Pub. Date: Apr. 25, 2002

(54) Liquid crystal display

(75) Inventors: Hidehiro Sonoda, Mobara (JP); Noboru Kunimatsu, Mobara (JP); Setsuo Kobayashi, Mobara (JP); Katsuhiko Ishii, Chosei (JP)

Correspondence Address: Stanley P. Fisher, Reed Smith Hazel & Thomas LLP, Suite 1400, 3110 Fairview Park Drive, Falls Church, VA, 22042-4503, US

(73) Assignee: Hitachi, Ltd.

(21) Appl. No.: 09/949,901

(22) Filed: Sep. 12, 2001

(30) Foreign Application Priority Data
Sep. 12, 2000 (JP) 2000-276517

(51) Int. Cl. C09K 19/02

(52) U.S. Cl. 349/177

(57) ABSTRACT

Creation of display image burn-in phenomena otherwise occurring due to the presence of an internal residual voltage(s) is suppressed. The polarization relaxation time constant τ of a dielectric film layer existing between a liquid crystal drive electrode and a liquid crystal layer is specifically set to fall within a range of five minutes.

### BACKGROUND OF THE INVENTION

1. Field of the Invention

The present invention relates to liquid crystal display devices and also relates to active matrix type liquid crystal display devices of the type employing the so-called in-plane switching schemes.

2. Description of the Related Art

A liquid crystal display device is designed to perform on-screen image display operations by applying an electric field to liquid crystal molecules of a liquid crystal layer being interposed between a pair of substrates, and letting the liquid crystal change in orientation or “alignment” direction, and then utilizing resultant optical changes of such liquid crystal as created thereby for visualization of on-screen images required.

Prior known active matrix liquid crystal display devices are typically arranged to employ twisted nematic (TN) display schemes, wherein the direction of an electric field being applied to liquid crystals is set at a specific direction that is almost perpendicular to substrate surfaces with the liquid crystals sandwiched therebetween for performing displaying by utilization of optical rotary polarizabilities of the liquid crystal layer.

On the other hand, liquid crystal display devices of the type using the so-called “in-plane switching (IPS)” scheme which employ more than one comb-shaped electrode while setting the direction of an electric field being applied to liquid crystals in a direction substantially parallel to substrate surfaces for performing displaying by use of complex refractivities of such liquid crystals are proposed for example in Published Examined Japanese Patent Application No. 63-21907, U.S. Pat. No. 4,345,249, PCT Pat. No. WO91/10936, Japanese Patent Laid-Open No. 160878/1994, and others.

This IPS scheme offers over traditional TN schemes several advantages as to wider viewing angles and lower load capacitances or else, and is the architecture that is rapidly advancing as a new active-matrix liquid crystal display device in place of the TN schemes.

In this IPS scheme, almost perfect in-plane switching operability is achievable in cases where the liquid crystals have negative dielectricity anisotropy when compared to those liquid crystals of the positive dielectricity anisotropy, as suggested in M. Oh-e, M. Yoneya and K. Kondo, JOURNAL OF APPLIED PHYSICS, 1997, Vol. 82, No. 4 at pp. 528-535. Achievement of such perfect in-plane switching makes more perfect the liquid crystal display device's view-angle enhancement including intermediate gradation levels or “gray scales” a more perfect one. Accordingly, in the IPS scheme, it will be preferable from the above viewpoint to use the liquid crystals having the negative dielectricity anisotropy.

Although with the IPS scheme comb-shaped electrodes are employed which are made of stripe-shaped opaque metals as provided within the surface of one of the substrates forming a pair, one type of IPS has recently been proposed and disclosed for example in S. H. Lee, S. L. Lee and H. Y. Kim, ASIA DISPLAY, 1998 at pp. 371-374 and also in S. H. Lee, S. L. Lee, H. Y. Kim and T. Y. Eom, Society for Information Display (SID) Digest, 1999, pp. 202-205, which is such that the electrodes are made of transparent conductive materials such as indium-tin-oxide (ITO) while letting the layout pitch of these comb- shaped electrodes be shorter than that of the prior art IPS scheme and, further, the use of liquid crystals with negative dielectricity anisotropy makes it possible for all the liquid crystals existing at upper part of a transparent comb-like electrode to offer alignment changeabilities even in the presence of only an electric field as formed at an edge portion of the comb electrode to thereby improve the resultant optical transmissivity and aperture ratio.

It has been reported in the above-identified documents that in the IPS scheme with a combination of such negative dielectricity anisotropy liquid crystals and short-pitch transparent comb-like electrodes, the transmissivity approximating in value to that of the TN scheme is made possible while retaining wide viewing angles nearly equal to that in the IPS scheme.

In liquid crystal display devices, it has been well known among those skilled in the art that upon application of a voltage waveform with a DC voltage superposed therewith to a liquid crystal layer, a DC voltage (DC offset voltage) can reside within the liquid crystal layer even after removal of such DC voltage.

And, as discussed on pages 70 to 73 of Chapter 2 of Liquid Crystal Display Architectures, written and edited by Shoichi Matsumoto and published from Sangyou Tosho Kabushiki Kaisha (1996), active-matrix liquid crystal display devices are such that even in ordinary liquid crystal driving, application of a DC voltage-superposed drive voltage waveform to the liquid crystal layer will possibly occur in view of the structure of an active drive element of the liquid crystal display device, which in turn makes it difficult when performing gradation or gray-scale displaying to completely prevent DC voltage superposition phenomena. Such phenomena will occur in common to both the TN scheme and the IPS scheme.

Irrespective of either the TN scheme or the IPS scheme, this “residual” DC voltage affects the brightness or luminance of the liquid crystal display device causing a brightness difference to take place between a portion to which the DC voltage was applied and a portion to which no such voltage was applied or, alternatively, between portions that are different from each other in intensity of the applied DC voltage. Hence, in case characters and/or graphic patterns are displayed a long time under ordinary drive conditions, the previously displayed characters and/or graphics will be continuously displayed as ghost images for a while even after having caused such display to disappear. Such phenomena are called “after-images” in the art to which the invention pertains, wherein while the after-images will finally disappear through gradual decrease in intensity thereof with elapse of time after its first appearance, it can take as long as 30 minutes until it becomes invisible to human eyes in some cases.

With regard to the mechanism of the residue of a DC offset voltage in the liquid crystal layer when a DC voltage is applied thereto, one model of it has been proposed in Shingaku Gihou EID 96-89 (1997-01) at pp. 29-30, which is for explanation based on the behavior of ions in the liquid crystal layer in traditional TN schemes as an example. According to this model, a DC voltage as charged at an orientation film and adsorption of ions to an orientation film for alignment of liquid crystals are considered as the cause of a DC residing within the liquid crystal layer. And it has been concluded that DC voltage residue for about several minutes is due to the orientation film's charge-up and relaxation and also that DC voltage residue for a very long time longer than the above is due to ion adsorption to the orientation film.

With the IPS scheme, there has been a problem that its afterimage level is inferior as compared to the TN scheme. The cause of this may be considered in the way which follows: in the case of the TN scheme, a liquid crystal alignment control layer and its associative liquid crystal layer are merely present between a pixel electrode and opposite or “counter” electrode; in the case of the IPS scheme, it has between such pixel electrode and counter electrode a dielectric film(s) in addition to the liquid crystal layer and liquid crystal alignment control layer. In brief, it is considered that while in the case of the TN scheme the DC voltage residence is determinable only by the orientation film, the case of the IPS scheme is such that its afterimage level is worse when compared to the TN scheme because of the presence of chargeup and relaxation of the orientation film and dielectric film. Additionally the ion adsorption to the orientation film is deemed similar in the TN scheme and IPS scheme. For the DC voltage residue phenomena occurring due to the orientation film's chargeup and relaxation, an afterimage suppression method has been proposed and disclosed in PUJPA No. 7-159786 in such a way that optimization is done for approximation of the product of dielectricity values and relative resistivities of a respective one of the orientation film and liquid crystal material to thereby reduce an internal residual voltage thus enabling suppression of afterimages. Unfortunately, even with this approach, complete realization of the above case example is difficult due to the fact that the resistivity of such orientation film is significantly higher than and different in the magnitude of order from that of the liquid crystal and also that with the IPS scheme the liquid crystal's capacitance stays less as compared to film capacitances.

### SUMMARY OF THE INVENTION

The present invention was made in view of the above technical background and its primary object is to provide a new and improved liquid crystal display device capable of avoiding or minimizing risks of display image burn-in phenomena otherwise occurring due to the presence of an internal residual voltage and also provide a method for manufacturing the liquid crystal display device.

A summary of a representative one of those inventive concepts as disclosed herein will be set forth in brief below.

To be brief, the liquid crystal display device in accordance with the present invention is characterized in that the dielectric polarization relaxation time constant τ of a dielectric film layer existing between a liquid crystal drive electrode and a liquid crystal layer for example is set to fall within a range of five (5) minutes.

The inventors as named herein have studied and researched the relation among multiple kinds of orientation films being formed between a pair of substrates and liquid crystal material plus undesired duplicate images near on-screen display images, known as ghost images or after-images, to reveal the fact that liquid crystal display devices with the dielectric polarization relaxation time constant τ of a dielectric layer existing between the liquid crystal drive electrode and liquid crystal layer being “rapid” are less in after-images.

Additionally, through our diligent studying activities while paying a careful attention to relations of physical property constants and size dimensions of the liquid crystal material, orientation films, dielectric films and electrodes which make up the liquid crystal display device, we also found out that it is possible to reduce the dielectric polarization relaxation time constant τ by appropriately defining these physical property constants and size relations thereof.

### BRIEF DESCRIPTION OF THE DRAWINGS

FIG. 1 is a diagram showing an embodiment of the liquid crystal display device in accordance with the present invention, which diagram shows Δε of liquid crystal material, relative dielectric constant and film thickness values of dielectric films, and relative dielectric constant and film thickness values of orientation films and the like;

FIG. 2 is an overall plan view diagram showing one embodiment of the liquid crystal display device in accordance with this invention;

FIG. 3 is a plan view diagram showing one embodiment of an pixel of the liquid crystal display device in accordance with the invention;

FIG. 4 is a diagram showing a sectional view taken along line IV-IV of FIG. 3;

FIG. 5 is a diagram showing a sectional view along line V-V of FIG. 3;

FIG. 6 is a diagram showing a pictorial sectional view of a pixel and equivalent circuitry in the lateral electric field scheme;

FIG. 7 is a diagram showing an arrangement of a film relative dielectric constant evaluation sample and a measurement method thereof;

FIG. 8 is a diagram showing apparatus for optical observation of an internal residual voltage; and

FIG. 9 is a graph showing with-time change characteristics of a brightness increase ratio of the liquid crystal display device embodying the invention.

### DESCRIPTION OF THE PREFERRED EMBODIMENTS

One preferred embodiment of the liquid crystal display device in accordance with the present invention will now be explained using the accompanying drawings below.

[Overall Arrangement]

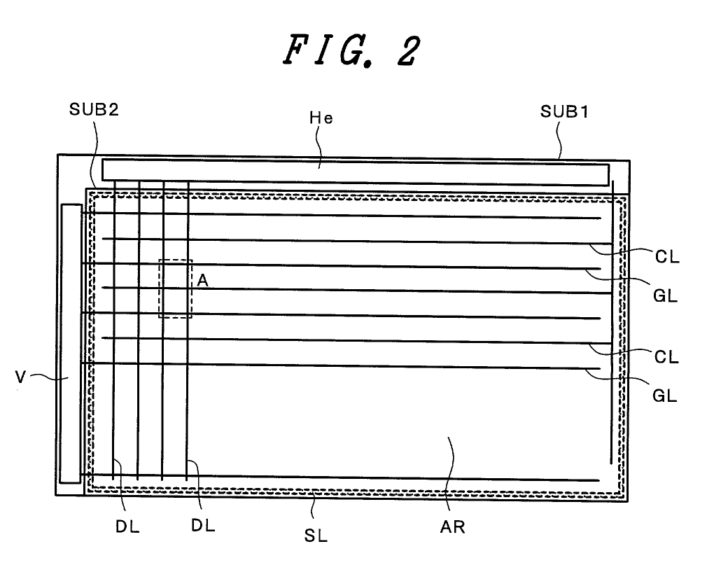

FIG. 2 is a plan view diagram showing one embodiment of the liquid crystal display device in accordance with this invention.

In FIG. 2, there is a transparent substrate SUB1, and this transparent substrate SUB1 is disposed to oppose a transparent substrate SUB2 with a layer of liquid crystal material being interposed therebetween.

Gate signal lines GL and opposite or “counter” voltage signal lines CL which extend in an “x” direction are formed on a surface of the transparent substrate SUB1 in such a manner that the gate signal lines GL and counter voltage signal lines CL are alternately provided in parallel to each other from the upper part of the drawing.

In addition, drain signal lines DL that extend in a “y” direction and are provided in parallel in the x direction are formed whereby a region being surrounded by mutually neighboring respective drain signal lines DL and mutually neighboring respective gate signal lines GL is for use as a pixel region (region as surrounded by a dotted line frame “A” in FIG. 2) while letting these pixel regions be disposed into a matrix form thus making up a display region AR.

While there are formed in a respective one of these pixel regions several components including a switching element (thin-film transistor TFT) that is to be driven by a scan signal from one-side gate signal line GL and a pixel electrode PX to which an image signal from the one-side drain signal line DL is supplied via this switching element plus an opposite or “counter” electrode CT which is for creating an electric field between it and this pixel electrode PX and is connected to the counter voltage signal line, details of this arrangement will be set forth later in the description.

Each gate signal line GL has its one end which is extended up to a terminate side portion (left side in FIG. 2) of the transparent substrate SUB1 and is connected to an output terminal of a vertical drive circuit (semiconductor integrated circuit) V that is mounted at the terminate side portion.

Similarly each drain signal line DL has its one end which is extended up to a terminate side portion (upper side in FIG. 2) of the transparent substrate SUB1 and is connected to an output terminal of an image drive circuit (semiconductor integrated circuit) He as mounted at the terminate side portion.

Additionally respective counter voltage signal lines CL have common-coupled terminate ends (right side in FIG. 2), to which a signal serving as a reference with respect to image signals is supplied.

The transparent substrate SUB2 is disposed in such a manner as to avoid or “bypass” the parts-mount regions of the vertical drive circuit V and image drive circuit He and is tightly attached or bonded at locations therearound to the transparent substrate SUB1 by a seal material which also functions to seal the liquid crystal.

[Arrangement of Pixel]

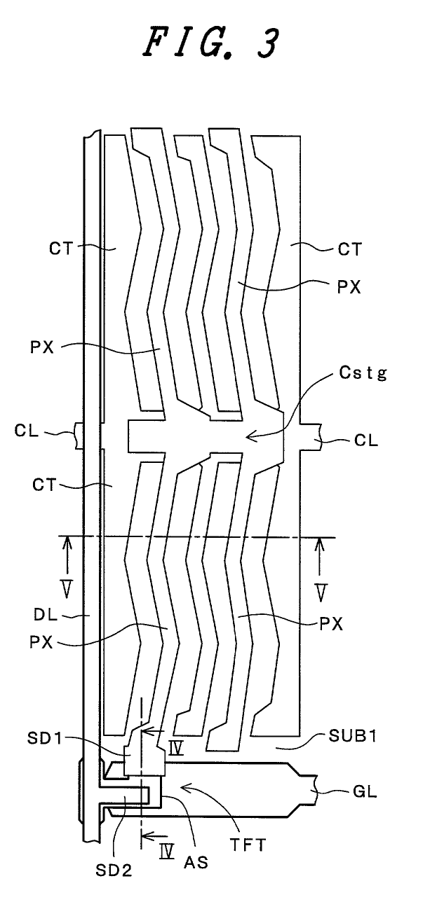

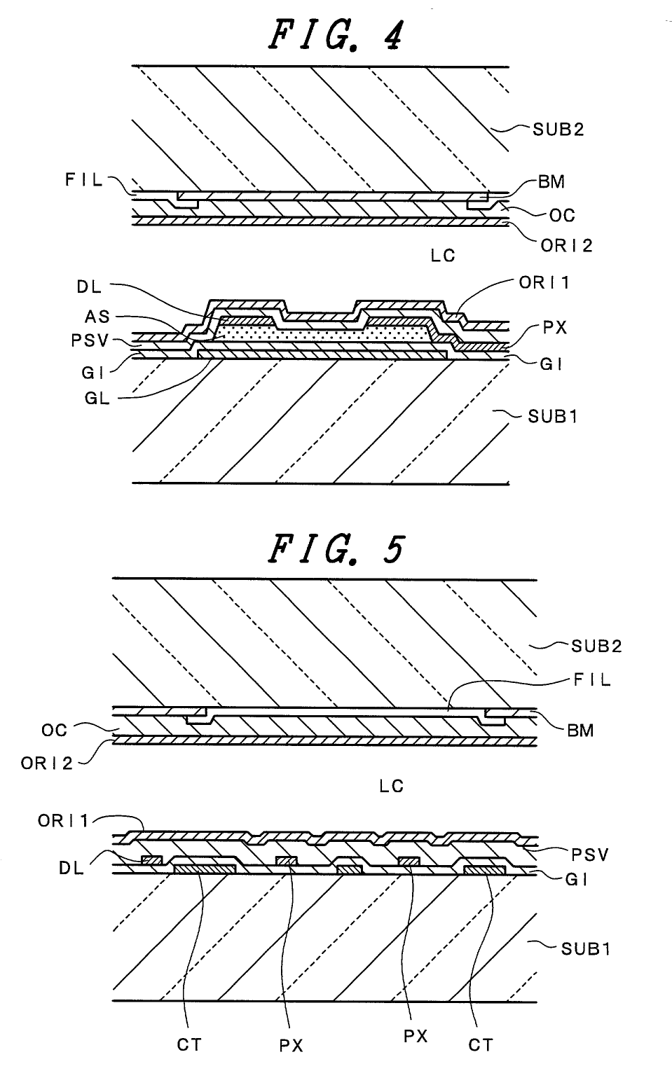

FIG. 3 is a plan view diagram showing one embodiment of the pixel region. Additionally a cross-sectional view as taken along line IV-IV of FIG. 3 is shown in FIG. 4 whereas a sectional view along line V-V of FIG. 3 is shown in FIG. 5.

Formed on a surface of the transparent substrate SUB1 are a gate signal line GL and counter voltage signal line CL, which extend in the x direction.

Here, the gate signal line GL is formed to run under the pixel region whereas the counter voltage signal line CL is formed to run centrally.

The counter voltage signal line CL is formed integrally with its associative counter electrode CT, wherein three lines are formed in FIG. 3 by way of example in such a manner that these counter electrodes CT extend within the pixel region in the y direction.

More specifically, one line of the three counter electrodes CT is formed so that it runs in the y direction at a central portion of the pixel region while letting the remaining two lines run in the y direction in such a manner as to be adjacent to drain signal lines DL as will be described later.

Here, although each counter electrode CT is formed into a zigzag shape along its extension direction, a detail of which will be explained at the part for explanation of the pixel electrode PX.

And, a dielectric film GI which is made for example of SiN is formed over the surface of the transparent substrate SUB1 while covering these gate signal line GL and counter voltage signal line CL (counter electrodes CT) also.

This dielectric film GI is designed so that it functions as a gate insulation film in the formation region of a thin-film transistor TFT as will be described later, serves as an interlayer dielectric film relative to the gate signal line GL and counter voltage signal line CL in the formation region of a drain signal line DL to be later described, and acts as a dielectric film in the formation region of a capacitive element Cstg to be described later.

A semiconductor layer AS made for example of amorphous silicon (a-Si) is formed over the dielectric film GI at part which overlaps the gate signal line GL and is adjacent to the to-be-later described drain signal line DL.

This semiconductor layer AS is a semiconductor layer of thin-film transistor TFT, wherein through formation of a drain electrode SD2 and source electrode SD1 on its surface, it is arranged as a switching element of the reverse-stagger structure with a portion of the gate signal line GL being used as the gate electrode thereof.

For instance the drain electrode SD2 of the thin-film transistor TFT is designed to be simultaneously formed during formation of the drain signal line DL and is to be formed by letting part of the drain signal line DL be formed to extend up to a surface of the semiconductor layer AS.

In addition the source electrode SD1 of the thin-film transistor TFT is arranged to be simultaneously formed during formation of the pixel electrode PX and is to be formed by letting part of the pixel electrode PX be formed to extend to the surface of the semiconductor layer AS.

The pixel electrode PX is such that two lines are formed to extend between respective ones of the three counter electrodes CT while having a distance to each counter electrode CT.

Each pixel electrode PX is formed into zigzag shape while having a plurality of bent/curved portions that are equally spaced along the extension direction of it.

With employment of such arrangement, the counter electrode CT is also formed into zigzag shape while having a plurality of bent/curved portions that are equally spaced along the extension direction thereof, wherein formation is done as a pattern as resulted from simple parallel movement of the pixel electrode PX in the x direction in FIG. 3.

It should be noted that the counter electrodes CT being placed on the both, right and left, sides of the pixel region is designed to have a shape slightly different from that of the centrally disposed counter electrode CT in order to preclude a gap space (this will becomes the cause for light leakage) between it and the drain signal line DL at an edge on the drain signal line DL side.

The use of such arrangement for forming the pixel electrode PX and counter electrodes CT into zigzag shape in this way is aimed at achievement of displaying without any risks of color gradation/tone changes even when observing from different directions relative to the normal of a display plane (this is called multi-domain scheme) by forming within the pixel region a region(s) different in electric field direction from the pixel electrode PX toward the counter electrode CT side.

Additionally two pixel electrodes PX are connected together at part overlapping the counter voltage signal line CL to thereby constitute a capacitive element Cstg between it and the counter voltage signal line CL at this connection portion.

This capacitive element Cstg has a function or else of permitting an image signal as has been supplied to the pixel electrode PX when the thin-film transistor TFT turned off to be accumulated a relatively long time.

A protective film PSV made for example of SiN is formed over the surface of the transparent substrate SUB1 with the drain signal lines DL and pixel electrodes PX being formed thereon in the way stated above while covering the drain signal lines DL and pixel electrodes PX also.

This protective film PSV is provided mainly for preclusion of direct contact of the thin-film transistor TFT with the liquid crystal: in view of this, it may be formed to at least cover or “wrap” the thin-film transistor TFT formation region.

And, an orientation film ORI1 is formed on a surface of this protective film PSV, wherein this orientation film ORI becomes a film that is brought into direct contact with the liquid crystal material LC for determination of the initial orientation or “alignment” direction of molecules of the liquid crystal LC.

More specifically this orientation film ORI1 is comprised of a resin film having a thickness of from 50 to 200 nanometers (nm) with the required orientation processing such as rubbing processing or the like having been applied to its surface as contacted with the liquid crystal LC (relative resistivity falls within a range of from 1.0×10⁹ Ω·cm to 1.0×10¹³ Ω·cm) in a specific direction that corresponds to the initial alignment direction of molecules of the liquid crystal LC. In the pixel arrangement of FIG. 3 the alignment processing direction is identical to the direction of drain signal lines DL in cases where liquid crystal material having positive dielectricity anisotropy is employed or, alternatively is equal to the direction of gate signal lines GL in case liquid crystal material with negative dielectricity anisotropy is used.

Note here that the transparent substrate SUB2 which is disposed to oppose the transparent substrate SUB1 thus arranged with the liquid crystal LC sandwiched therebetween while setting a gap at 4.5 μm (in the liquid crystal sealed state) by way of example has its liquid crystal side surface on which a black matrix BM is formed. This black matrix BM is formed to be partitioned from other neighboring pixel regions and is formed at a certain peripheral portion excluding the central portion of each pixel region.

Also note that this black matrix BM is provided in order to prevent irradiation of external light rays onto thin-film transistors TFT.

A color filter FIL is formed at the center of a pixel region surrounded by the black matrix BM, wherein this color filter FIL becomes for example a filter of a common color to respective pixels as arrayed in parallel in the y direction and wherein formation is done repeatedly in the order of red (R), green (G) and blue (B) in the x direction by way of example.

A planarization film OC that is comprised for example of a resin layer is formed on the surface of the transparent substrate SUB2 while also covering the black matrix BM and color filter FIL, wherein an orientation film OR12 is formed on or over this planarization film OC's surface. In a way Similar to the above-noted orientation film ORI1, this orientation film OR12 becomes a film that is in direct contact with the liquid crystal LC for determination of the initial alignment direction of molecules of the liquid crystal LC.

Additionally the embodiment stated above is the one that employs an inorganic film made for example as SiN for use as the protective film PSV. However, needless to say, it may be modified to have an arrangement with more than one resin film or else being coated on the upper surface of such inorganic film-that is, a composite structure with a mixture of organic and inorganic films.

The above-stated pixel arrangement is the one that shows one embodiment as a liquid crystal display device of the type incorporating the lateral electric field scheme, and will be applicable to any other similar ones as far as these are designed so that a pair of electrodes for creation of an electric field are formed on one transparent substrate side while controlling the optical transmissivity of the liquid crystal LC by components of this electric field in a direction parallel to the transparent substrate.

One example is that it is also applicable to the one which consists essentially of a straight-shaped or linear pattern while letting pixel electrodes PX and counter electrodes CT have no bent/curved portions.

Another example is that it is also applicable to the one in which either one of the pixel electrode PX and counter electrode CT is comprised of a transparent electrode or, alternatively, to the one with both of them being formed of transparent electrodes.

While certain one of those with both the pixel electrode PX and counter electrode CT being formed of transparent electrodes has been well known which is designed so that one electrode is formed in almost an entire region of a pixel region whereas the other is formed to have a comb-shaped pattern, it will be able to be applied in such arrangements also.

[Consideration on After-image Creation]

Burn-in after-image phenomena of on-screen display images of the liquid crystal display device having the aforesaid arrangement may include an AC afterimage and a DC afterimage. The DC afterimage is a phenomenon that due to influence of residual charge carriers, a previous display becomes less brighter or dimmer even upon selection of the next display signal. It is considered that this mechanism is due to the fact that adsorbed charge behaves to reside on an orientation film interface even after having removed voltage application and that an internal residual DC voltage generates in accordance with a pseudo-electric field(s) as formed by this charge.

In order to suppress or minimize the creation of such burn-in afterimage, it will become important to employ as the materials of the liquid crystal LC and/or orientation films ORI a specific material which permits any internal residual voltages to readily release or “escape” therefrom.

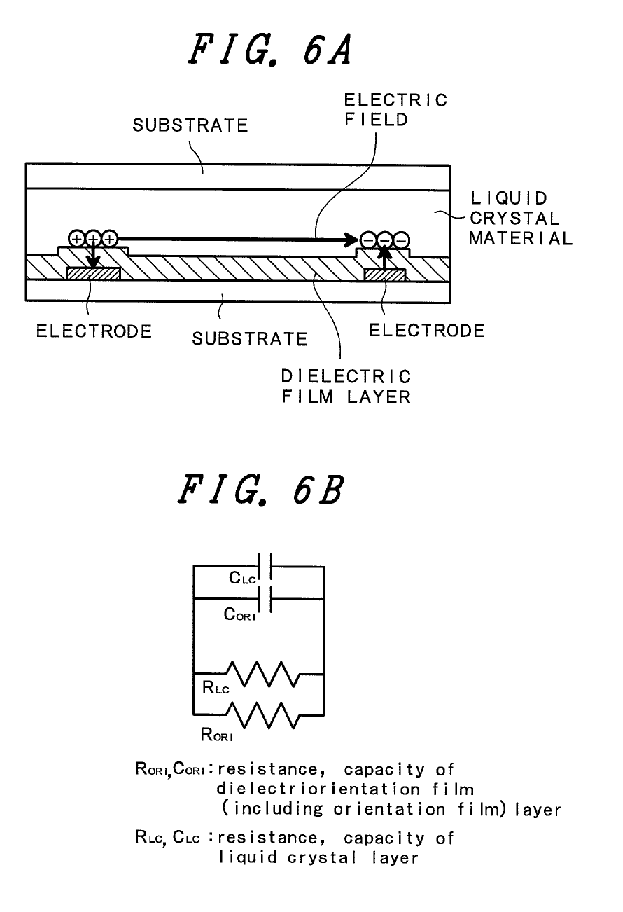

The phenomena of relaxation of the liquid crystal layer's burn-in occurring due to the presence of such internal residual voltage may be well explained by taking into consideration the transient phenomenon of electrical charge being accumulated on the dielectric film(s) and/or liquid crystal layer. FIG. 6A is a diagram showing a simplified sectional view of the display unit of a liquid crystal display device of the type which incorporates the lateral electric field scheme, which may be represented by an equivalent circuit such as shown in FIG. 6B. In this case, if in FIG. 6A a DC voltage is applied between a pair of electrodes then electrical charge carriers are accumulated or “integrated” at the liquid crystal and/or dielectric film(s). Immediately after stoppage or interruption of the DC voltage, these charge carriers will be relaxed through the liquid crystal layer and/or dielectric film(s). In this case, it can be represented by an electrical equivalent circuit such as shown in FIG. 2. At this time, letting a time from an instant when the DC voltage has stopped be “t,” the charge “q” residing at the liquid crystal layer and/or dielectric film(s) is given by the Equation (2) which follows:

$$q = {q}_{0} exp ( - \frac{t}{CR} ) = {q}_{0} exp \{ - \frac{{R}_{ORI} + {R}_{LC}}{( {C}_{ORI} + {C}_{LC} ) \cdot {R}_{ORI} {R}_{LC}} \cdot t \} \qquad ( 2 )$$

where R_{ORI} is the resistivity of a dielectric film, R_{LC} is the resistivity of liquid crystal, C_{ORI} is the capacitance of dielectric film, C_{LC} is the capacitance of liquid crystal, and q₀ is the accumulated charge amount immediately before discharging.

From this Equation (2), the relaxation of residual charge will decrease with time, and the relaxation time constant τ may be given by the following Equation (3):

$$τ = \frac{{R}_{ORI} {R}_{LC} ( {C}_{ORI} + {C}_{LC} )}{{R}_{ORI} + {R}_{LC}} \qquad ( 3 )$$

The embodiment stated supra is such that it is possible, by setting the relaxation time constant τ in its measurement method fall within a range of five (5) minutes while at the same time selecting the dielectric film(s) and liquid crystal with this standard used therefor, to obtain an improved liquid crystal display device capable of letting afterimages readily disappear.

Further, defining and optimizing physical property values of film capacitances (in the above embodiment, the dielectric film GI and protective film PSV) makes it possible to further reduce burn-in afterimages of display images otherwise occurring due to the presence of an internal residual voltage. With the lateral electric field scheme with the electrode resistance made wider, the dielectric film typically becomes greater in capacitance than the liquid crystal; regarding the resistivity, the latter becomes greater than the former. By taking account of this fact, the relaxation time constant τ may be approximated by the following Equation (4):

$$τ = \frac{{R}_{ORI} {R}_{LC} ( {C}_{ORI} + {C}_{LC} )}{{R}_{ORI} + {R}_{LC}} ≅ {R}_{LC} {C}_{ORI} = {ρ}_{LC} \cdot {ϵ}_{0} \cdot {ϵ}_{ORI} \cdot \frac{{ⅆ}_{PXCT}}{{ⅆ}_{ORI}} \qquad ( 4 )$$

Here, ρ_{LC} is the relative resistivity of liquid crystal LC, ε₀ is the dielectricity of vacuum, ε_{ORI} is the relative dielectric constant of dielectric film ORI, d_{PXCT} is the electrode distance (distance between pixel electrode PX and counter electrode CT), and d_{ORI} is the thickness of dielectric film ORI.

More specifically the liquid crystal LC's relative resistivity and the dielectric layer ORI's relative dielectric constant and film thickness plus the distance between a pair of electrodes (PX-CT) exhibit certain coreleation with the internal residual voltage. Regarding the liquid crystal's relative resistivity and the dielectric film's relative dielectric constant along with the electrode distance, the less the values thereof, the shorter the resulting relaxation time. In addition, with the embodiment of the invention, since certain ones of these parameters—i.e. the dielectric film ORI's relative dielectric constant ε_{ORI} and film thickness and the distance between pair of electrode (PX-CT)-are optimized, it becomes possible to accelerate outward drainage or “dumping” of the internal residual voltage that can cause unwanted DC afterimages.

Note here that the dielectric film lying between the liquid crystal layer and electrode may consist essentially of an orientation film or, alternatively, be comprised of a composite layer of more than one orientation film and interlayer dielectric film(s). Even in cases where the dielectric film is formed of such composite layer, it is possible to speed up the outward drainage of an internal residual voltage more significantly with a decrease in the relative dielectric constant of each dielectric film and also with an increase in film thickness because of the fact that the capacitance and resistivity values of respective constituent layers are combined together for contribution to the relaxation phenomena.

[Practical Arrangement of Dielectric film, Orientation Film and Electrode Distance or the Like]

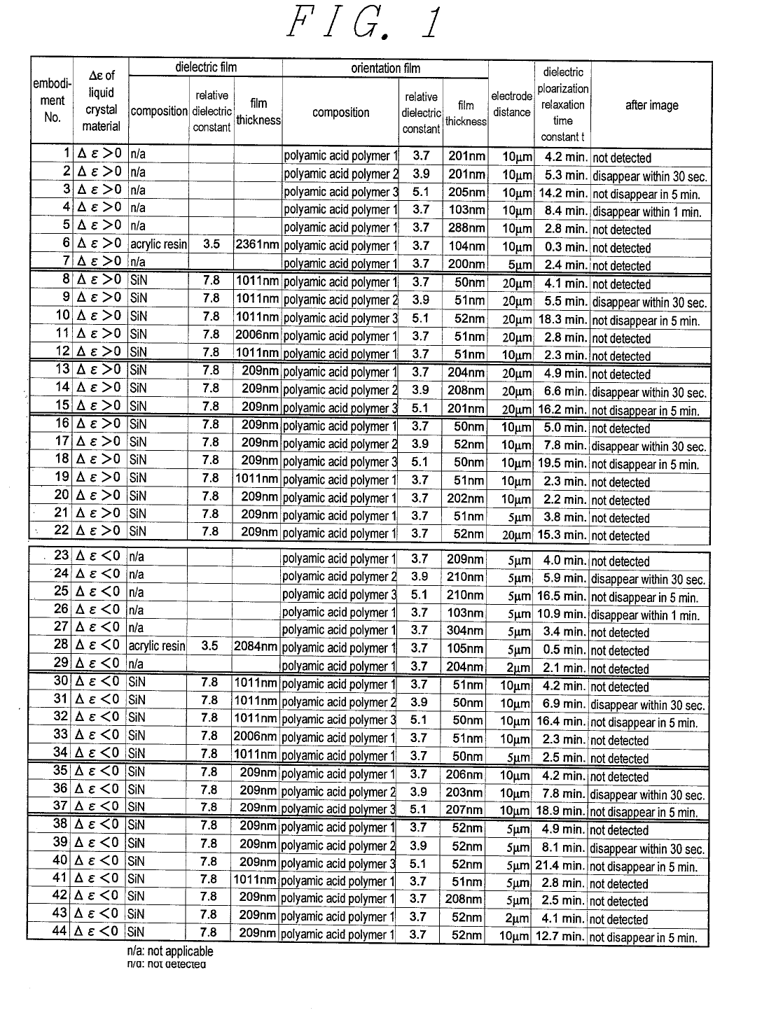

FIG. 1 is a table which indicates, in the above-stated lateral electric field type liquid crystal display device, liquid crystal materials (Δε>0 or Δε<0), the presence or absence of dielectric film, its relative dielectric constant and film thickness of such dielectric film if any, the afterimage relaxation time constant τ in case the distance of electrodes forming a pair is formed to have different values, and an afterimage measurement disappearance time (minutes).

Additionally, upon execution of measurement of the afterimage measurement disappearance time (minutes), its afterimage evaluation, the dielectric film's relative dielectric constant evaluation, and DC afterimage measurement method were done by the methodology which follows.

[Afterimage Evaluation]

A time as taken for a visually observed afterimage to disappear at a fixed pattern display portion(s) was measured in the event that black display is done on the entire screen after having applied a fixed pattern (gradation resulting in achievement of maximal brightness or luminance) onto a black display area at 25° C. for 30 minutes.

Here, lowercase letter “a” is used to designate the case where such afterimage disappeared within 30 seconds; “b” designates the case where the afterimage disappeared within a time period ranging from about 30 seconds to 1 minute; and, “c” denotes the case where the afterimage does not disappear even after elapse of more than 5 minutes.

[Film Relative Dielectric Constant Evaluation]

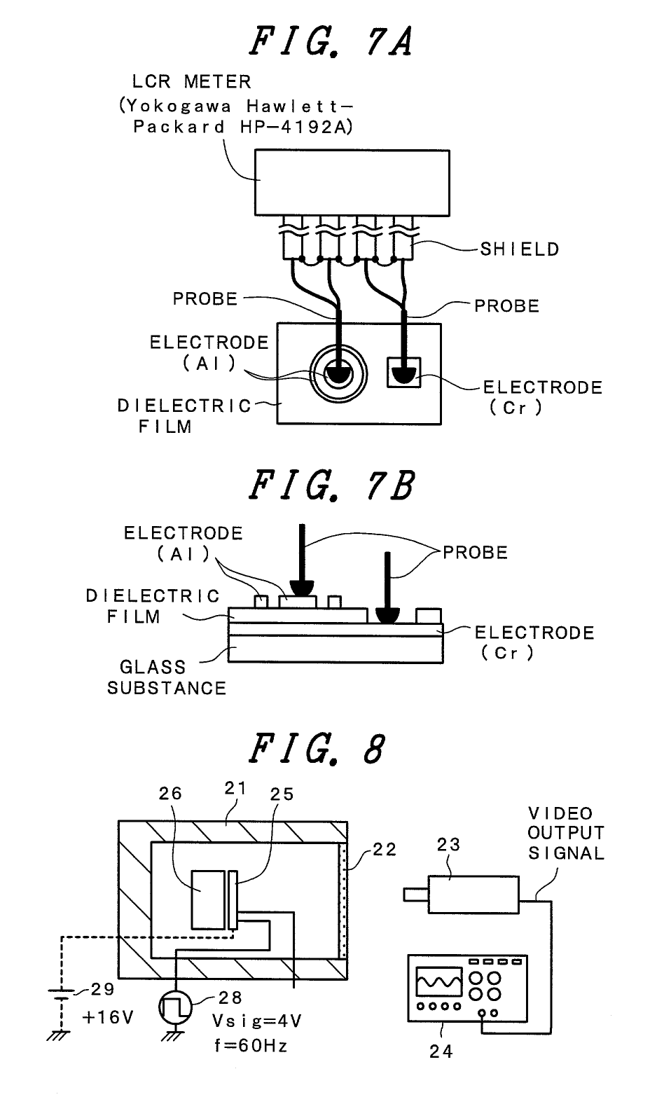

A sample for film relative dielectric constant evaluation was prepared in the way which follows. Note that a diagram showing the sample's arrangement and measurement is shown in FIG. 7. Additionally FIG. 7A is a plan view diagram, and FIG. 7B depicts a cross-sectional view.

(1) A chromium metal layer was fabricated by sputtering techniques as a film on a glass substrate (AN635 manufactured by Asahi Garasu). Its film thickness was set at 0.2 μm.

(2) A dielectric film was deposited on the chromium metal layer to a thickness of 0.5 μm and then subject to baking process.

(3) Aluminum electrodes having a pattern shown in FIG. 7A were formed by mask vapor deposition on an orientation film. Its film thickness was 0.3 μm.

Measurement of the relative dielectric constant is such that 4-terminal method was used for measurement while letting a prober be contacted as shown in the same drawing. A measurement machine used was the impedance analyzer HP4192A as manufactured by Hewlett-Packard Company. A temperature and humidity during measurement were set at 25° C. and 60%RH, respectively. While setting a measurement frequency at 100 Hz, a film capacitance C was measured in a parallel equivalent circuit mode, thereby calculating the relative dielectric constant ε by use of the following Equation (5).

ε=C·(d/Sε₀) (5)

where d is the film thickness, S is the electrode area, and ε₀ is the dielectricity of vacuum (8.854×10¹² F/m).

[DC Afterimage Measurement Method]

An internal residual voltage that can take place after removal of voltage application was optically observed. Upon application of AC to a liquid crystal display cell(s) at which an internal residual voltage resides, flicker is generated causing the brightness or luminance to change accordingly; thus, a change in brightness corresponds to the internal residual voltage. The way that this brightness becomes relaxed was observed.

FIG. 8 is an arrangement diagram showing a measurement system for evaluation of a with-time variation of B-V characteristic. In this drawing, 21 is a constant temperature oven also known as thermostatic chamber, 22 is an observation window (glass window), 23 is a digital multimeter, 24 is a measurement controller, 25 is a sample (liquid crystal panel), 26 is a backlight, 28 is an AC drive voltage source, and 29 is a DC voltage source. A temperature within the constant temperature oven was set at 25° C., and its humidity was at 50%RH. Additionally, measurement was designed to get started after elapse of 1 hour after completion of measurement preparation.

The liquid crystal display panel 25 is arranged so that a DC voltage can be superposed in addition to an AC drive voltage. In addition the liquid crystal panel 25 has a gate to which DC drive is done causing +16V to be input to the gate. An output from a brightness meter is input by the digital multimeter to the measurement controller 24 as a brightness value. And, through the steps of (1) to (3) given below, the brightness after disappearance of the DC application voltage was measured.

(1) The AC drive voltage was a voltage that results in achievement of 10% of the maximum brightness in any events.

(2) The state in which a DC voltage of 0.5V was applied was continued for 30 minutes.

(3) After turn-off of only the DC voltage, the brightness was further measured additionally for 30 minutes. The brightness measurement interval was set at 30 seconds.

The resulting time-brightness characteristic as obtained thereby was then subject to regression processing until an error in the following Equation (6) becomes less than or equal to 10⁻⁵. A specific one of resultant time constants τ₁, τ₂, which is greater in time constant value, was for use as the relaxation time constant τ.

B=A0+A1exp(−t/τ1)+A2exp(−t/τ2) (6)

where B is the brightness, A1, A2 are constants, and t is time.

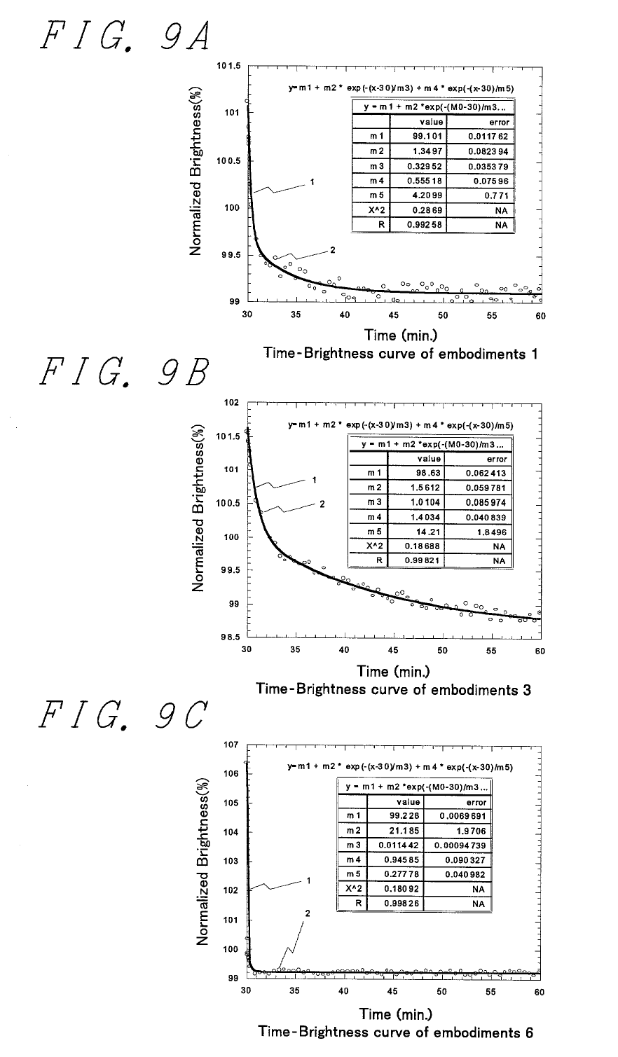

FIGS. 9A, 9B and 9C are graphs showing time-brightness characteristics as obtained by embodiments 1, 3, 6 of FIG. 1, respectively: in these drawings, reference numeral “2” designates the actually measured brightness values (relative values with respect to the initial brightness prior to DC application), and numeral “1” indicates a curve with regression processing applied thereto.

According to this graph, it would be appreciated that the brightness rapidly decreases with time and then converges to a specific value. As a result of execution of the regression processing at Equation (6), τ1 is 0.3 and 2 is 4.2 for the embodiment 1, resulting in the relaxation time constant τ becoming 4.2 minutes. In regard to the embodiment 2, τ1 is 1.0 and τ2 is 14.2 so that the relaxation time constant τ becomes 14.2 minutes. Regarding the embodiment 3, τ1 is 0.01 and τ2 is 0.3; thus, the relaxation time constant τ becomes 0.3 minutes. As for the other embodiments also, a graph with the shape of the embodiment 3 is obtainable in an examples with a longer relaxation time constant whereas a graph with the shape of the embodiment 6 is obtainable in an example with a shorter relaxation time constant.

It is apparent from viewing FIG. 1 that the use of the liquid crystal display device in accordance with the embodiment of the invention with the dielectric film's relaxation time constant τ being set at 5 minutes or less makes it possible to extremely lessen any possible display image burn-in phenomena otherwise occurring due to the presence of an internal residual voltage(s).

It is also indicated that in order to obtain the intended liquid crystal display device with the above-noted relaxation time constant τ being set at 5 minutes or less, such is achievable by optimization of the film thickness and relative dielectric constant of more than one dielectric film existing between the drive electrode(s) and liquid crystal layer along with the electrode distance concerned.

The embodiments 1, 2, 3 are examples of the case where the dielectric film's relative dielectric constant was changed in value, indicating that the relaxation time constant becomes shorter with a decrease in relaxation time constant. This relationship is also established even in cases where the constituent components of embodiments 8, 9, 10 or else are modified.

Also note that embodiments 1, 4, 5, 6 are examples of the case where the dielectric film's film thickness changes in value, indicating that the relaxation time constant becomes shorter with a decrease in film thickness.

Further note that embodiments 1, 7 are examples of the case where the electrode distance of liquid crystal drive electrodes changes in value, indicating that the relaxation time constant is short when the electrode distance is short.

The above-noted tendency supports Equation (4) as has been indicated at the part for consideration of the afterimage generation; accordingly, optimizing the film thickness and relative dielectric constant of more than one dielectric film existing between the drive electrode(s) and liquid crystal layer along with the electrode distance makes it possible to obtain the liquid crystal display device with the aforementioned relaxation time constant τ being set at 5 minutes or less.

Practically as shown by embodiments 1-7, in case a liquid crystal material with positive dielectricity anisotropy is used while letting all the dielectric films be comprised of organic films, the intended results are accomplishable by letting the relative dielectric constant be set at 3.8 or less, the film thickness fall within a range of from 200 nm to 3.0 μm, and the electrode distance of liquid crystal drive electrodes range from 5 to 10 μm.

Alternatively as shown by embodiments 8-12, in case a liquid crystal material with positive dielectricity anisotropy is employed while letting a dielectric film be comprised of a composite film of organic and inorganic films, the intended results are obtainable by designing the organic film so that the relative dielectric constant of it is set at 3.8 or less and the film thickness falls within a range of 50 to 200 nm while arranging the inorganic film so that its film thickness ranges from 1 to 3 μm and its relative dielectric constant is set at 9 or less with the electrode distance of liquid crystal drive electrodes ranging from 10 to 20 μm.

Still alternatively, as shown by embodiments 13-15, in case a liquid crystal material with positive dielectric anisotropy is used while letting a dielectric film be comprised of a composite film of organic and inorganic films, the intended results are attainable by designing the organic film so that its relative dielectric constant is set at 3.8 or below and the film thickness falls within a range of 200 nm to 3 μm while arranging the inorganic film so that its film thickness ranges from 200 nm to 1 μm and its relative dielectric constant is set at 9 or less with the electrode distance of liquid crystal drive electrodes ranging from 10 to 20 μm.

Further alternatively, as shown by embodiments 16-22, in case a liquid crystal material with positive dielectricity anisotropy is used while letting a dielectric film be comprised of a composite film of organic and inorganic films, the intended results are attainable by designing the organic film so that its relative dielectric constant is set at 3.8 or less and its film thickness falls within a range of 50 to 200 nm while arranging the inorganic film so that its film thickness ranges from 200 nm to 1 μm and relative dielectric constant is set at 9 or less with the electrode distance of liquid crystal drive electrodes ranging from 5 to 10 μm.

Alternatively as shown by embodiments 23-29, in case a liquid crystal material with negative dielectricity anisotropy is used, the intended results are obtainable by setting the relative dielectric constant at 3.8 or less, the film thickness fall within a range of from 200 nm to 3.0 μm, and the electrode distance of liquid crystal drive electrodes range from 2 to 5 μm.

Alternatively, as shown by embodiments 30-34, in case a liquid crystal material with negative dielectricity anisotropy is used while letting a dielectric film be comprised of a composite film of organic and inorganic films, the intended results are achievable by designing the organic film so that the relative dielectric constant thereof is set at 3.8 or less and the film thickness falls within a range of 50 to 200 nm while arranging the inorganic film so that its film thickness ranges from 1 to 3 μm and its relative dielectric constant is set at 9 or less with the electrode distance of liquid crystal drive electrodes ranging from 5 to 10 μm.

Alternatively as shown by embodiments 35-37, in case a liquid crystal material with negative dielectric anisotropy is used while letting a dielectric film be comprised of a composite film of organic and inorganic films, the intended results are attainable by designing the organic film so that its relative dielectric constant is set at 3.8 or below and the film thickness falls within a range of 200 nm to 3 μm while arranging the inorganic film so that its film thickness ranges from 200 nm to 1 μm and its relative dielectric constant is set at 9 or less with the electrode distance of liquid crystal drive electrodes ranging from 5 to 10 μm.

Alternatively as shown by embodiments 38-44, in case a liquid crystal material with negative dielectric anisotropy is used while letting a dielectric film be comprised of a composite film of organic and inorganic films, the intended results are attainable by designing the organic film so that its relative dielectric constant is set at 3.8 or less and its film thickness falls within a range of 50 to 200 nm while arranging the inorganic film so that its film thickness ranges from 200 nm to 1 μm and relative dielectric constant is set at 9 or less with the electrode distance of liquid crystal drive electrodes ranging from 2 to 5 μm.

As apparent from the foregoing explanation, according to the liquid crystal display device embodying the present invention, display image burn-in phenomena otherwise occurring due to the presence of an internal residual voltage(s) will hardly occur.

What is claimed is:

1. An active matrix type liquid crystal display device comprising a pair of substrates at least one of which is transparent, a liquid crystal alignment control layer being formed on or over mutually opposing surfaces of said pair of substrates, a liquid crystal layer comprised of a liquid crystal composition with its dielectricity anisotropy of positive or negative polarity as disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein: the dielectric film layer existing between said electrode and said liquid crystal layer has a polarization relaxation time constant τ as set to fall within a range of 5 minutes.

2. An active matrix type liquid crystal display device comprising a pair of substrates at least one of which is transparent, a liquid crystal alignment control layer being formed on or over mutually opposing surfaces of said pair of substrates, a liquid crystal layer comprised of a liquid crystal composition with its dielectricity anisotropy of positive or negative polarity as disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein: a direct current (DC) voltage of 0.5V for 30 minutes is continuously applied in addition to an alternate current (AC) drive voltage becoming 10% of a maximal brightness; and
regression processing is applied with a regression curve which defines a time-relaxation characteristic of an after image after having turned the DC voltage off by an equation (1) as will be given below, while setting a resultant relaxation time constant to fall within a range of 5 minutes.
B=Aexp(−t/τ) (1)
wherein B is the brightness, A is a constant, t is a time, and τ=2.8098.

3. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a positive dielectricity anisotropy is used; and the dielectric film layer existing between said electrode and said liquid crystal layer consists of an organic film with its relative dielectric constant less than or equal to 3.8 and also with a film thickness being greater than or equal to 200 nm and yet less than or equal to 3.0 micrometers (μm) while letting an electrode distance of more than one liquid crystal drive electrode being set at 5 to 10 μm.

4. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a positive dielectricity anisotropy is used; and the dielectric film layer existing between said electrode and said liquid crystal layer is formed of a composite structure of an organic film and an inorganic film, wherein the organic film has a film thickness of 50 to 200 nm and relative dielectric constant of 3.8 or less whereas the inorganic film has a film thickness of 1 to 3 μm and relative dielectric constant of 4 to 9 with an electrode distance of liquid crystal drive electrode being set at 10 to 20 μm.

5. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a positive dielectricity anisotropy is used; and the dielectric film layer existing between said electrode and said liquid crystal layer is formed of a composite structure of an organic film and an inorganic film, wherein the organic film has a film thickness of 200 nm to 3 μm and relative dielectric constant of 3.8 or less whereas the inorganic film has a film thickness of 200 nm to 1 μm and relative dielectric constant of 4 to 9 with an electrode distance of liquid crystal drive electrode being set at 10 to 20 μm.

6. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a positive dielectricity anisotropy is used; and the dielectric film layer existing between said electrode and said liquid crystal layer is formed of a composite structure of an organic film and an inorganic film, wherein the organic film has a film thickness of 50 to 200 nm and relative dielectric constant of 3.8 or less whereas the inorganic film has a film thickness of 200 nm to 1 μm and relative dielectric constant of 4 to 9 with an electrode distance of liquid crystal drive electrode being set at 5 to 10 μm.

7. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a negative dielectricity anisotropy is used; and the dielectric film layer existing between said electrode and said liquid crystal layer consists of an organic film with its relative dielectric constant of 3.8 or less and also with a film thickness being greater than or equal to 200 nm and yet less than or equal to 3.0 μm while letting an electrode distance of more than one liquid crystal drive electrode being set at 2 to 5 μm.

8. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a negative dielectricity anisotropy is used; and the dielectric film layer existing between said electrode and said liquid crystal layer is formed of a composite structure of an organic film and an inorganic film, wherein the organic film has a film thickness of 50 to 200 nm and relative dielectric constant of 3.8 or below whereas the inorganic film has a film thickness of 1 to 3 μm and relative dielectric constant of 4 to 9 with an electrode distance of liquid crystal drive electrode being set at 5 to 10 μm.

9. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a negative dielectricity anisotropy is used; and the dielectric film layer existing between said electrode and said liquid crystal layer is formed of a composite structure of an organic film and an inorganic film, wherein the organic film has a film thickness of 200 nm to 3 μm and relative dielectric constant of 3.8 or less whereas the inorganic film has a film thickness of 200 nm to 1 μm and relative dielectric constant of 4 to 9 with an electrode distance of liquid crystal drive electrode being set at 5 to 10 μm.

10. An active matrix type liquid crystal display device comprising a pair of substrates at least one of which is transparent, a liquid crystal alignment control layer being formed on or over mutually opposing surfaces of said pair of substrates, a liquid crystal layer disposed between said pair of substrates while being in contact with said liquid crystal alignment control layer, a pixel electrode and counter electrode as formed over one substrate of said pair with a dielectric film interposed therebetween, and an active element connected to said pixel electrode and counter electrode, wherein:
a liquid crystal having a negative dielectricity anisotropy is used; and the dielectric film layer existing between said electrode and said liquid crystal layer is formed of a composite structure of an organic film and an inorganic film, wherein the organic film has a film thickness of 50 to 200 nm and relative dielectric constant of 3.8 or less whereas the inorganic film has a film thickness of 200 nm to 1 μm and relative dielectric constant of 4 to 9 with an electrode distance of liquid crystal drive electrode being set at 2 to 5 μm.
